(19) United States
(12) Patent Application Publication
(10) Pub. No.: US 2017/0002873 A1
(43) Pub. Date: Jan. 5, 2017

(54) FRICTION MATERIAL GROOVE PATTERN

(71) Applicant: DEERE & COMPANY, Moline, IL (US)

(72) Inventors: CLAYTON P. NEUMANN, CEDAR FALLS, IA (US); DUANE F. MEYER, HUDSON, IA (US)

(21) Appl. No.: 14/799,644

(22) Filed: Jul. 15, 2015

Related U.S. Application Data
(60) Provisional application No. 62/188,002, filed on Jul. 2, 2015.

(51) Int. Cl. F16D 13/64; F16D 65/12

(52) U.S. Cl. CPC F16D 13/64; F16D 65/127; F16D 2065/1324

(57) ABSTRACT

In accordance with an example embodiment, a friction disk may include friction material positioned on a first side of the disk. The friction material may include a first plurality of grooves extending from an inner diameter of the friction material to an outer diameter of the friction material, and a second plurality of grooves extending in a radial direction from the inner diameter and ending prior to the outer diameter. The second plurality of grooves may have a substantially uniform width. The second plurality of grooves may be both deeper and wider than the first plurality of grooves. The first and second plurality of grooves may be interconnected so that fluid can flow from the second plurality of grooves into the first plurality of grooves.

### CROSS-REFERENCE TO RELATED APPLICATIONS

This application claims the benefit of U.S. Provisional Application No. 62/188,002, titled Friction Material Groove Pattern, filed Jul. 2, 2015, which is hereby incorporated by reference in its entirety.

### FIELD OF THE DISCLOSURE

The present disclosure relates generally to a groove pattern for the friction facing of a clutch or brake disk.

### BACKGROUND

A clutch or brake disk can include an inner metal core with a friction material arranged on one or both sides of the core. The friction material can include a pattern of grooves which allows a lubricating or cooling fluid to flow across the friction material within the pattern of grooves. The fluid can flow from the inner diameter of the clutch or brake disk to the outer diameter transferring heat away from the friction material.

### SUMMARY

This summary is provided to introduce a selection of concepts that are further described below in the detailed description and accompanying drawings. This summary is not intended to identify key or essential features of the appended claims, nor is it intended to be used as an aid in determining the scope of the appended claims.

According to an aspect of the present disclosure, a friction disk may include a friction material positioned on a first side of the disk. The friction material may include a first plurality of grooves extending across the width of the friction material, and a second plurality of grooves extending in a radial direction a length less than the width of the friction material. The second plurality of grooves may have a substantially uniform width. The second plurality of grooves may be both deeper and wider than the first plurality of grooves. The first and second plurality of grooves may be interconnected so that fluid can flow from the second plurality of grooves into the first plurality of grooves.

According to an aspect of the present disclosure, a friction disk may include a disk and a friction material positioned on a first side of the disk. The friction material may include a first plurality of grooves extending from an inner diameter of the friction material to an outer diameter of the friction material, and a second plurality of grooves extending in a radial direction from the inner diameter and ending prior to the outer diameter. The second plurality of grooves may have a substantially uniform width. The second plurality of grooves may be both deeper and wider than the first plurality of grooves. The first and second plurality of grooves may be interconnected so that fluid can flow from the second plurality of grooves into the first plurality of grooves.

According to an aspect of the present disclosure, a method of positioning grooves in friction material for a friction disk may include positioning a first plurality of grooves on the surface of the friction material, the first plurality of grooves extending from an inner diameter of the friction material to an outer diameter of the friction material; and positioning a second plurality of grooves on the surface of the friction material, the second plurality of grooves extending from the inner diameter in a radial direction and ending prior to the outer diameter, the second plurality of grooves having a substantially uniform width, the second plurality of grooves being deeper and wider than the first plurality of grooves, the first and second plurality of grooves being interconnected so that fluid can flow from the second plurality of grooves into the first plurality of grooves. The second plurality of grooves can be positioned on the friction material before the first plurality of grooves.

According to an aspect of the present disclosure, a method of positioning grooves in the friction material for a clutch or brake disk may include punching a ring from a sheet of friction material; impregnating the ring with an adhesive; punching radial grooves in the inner diameter of the ring of friction material; bonding the ring of friction material to a metal core; and pressing a pattern of grooves in the ring of friction material.

These and other features will become apparent from the following detailed description and accompanying drawings, wherein various features are shown and described by way of illustration. The present disclosure is capable of other and different configurations and its several details are capable of modification in various other respects, all without departing from the scope of the present disclosure. Accordingly, the detailed description and accompanying drawings are to be regarded as illustrative in nature and not as restrictive or limiting.

### BRIEF DESCRIPTION OF THE DRAWINGS

The detailed description of the drawings refers to the accompanying figures in which:

FIG. 1 is a schematic of a transmission, according to one embodiment;

FIG. 2 is a perspective view of a clutch, according to one embodiment;

FIG. 3 is a perspective view of a friction disk, according to one embodiment;

FIG. 3A is an enlarged partial perspective view of a friction disk, according to one embodiment;

FIG. 4 is a perspective view of a friction disk, according to one embodiment;

FIG. 5 a cross-sectional view of the friction disk shown in FIG. 3, according to one embodiment; and

FIG. 6 is a flow diagram illustrating a method of positioning grooves in the friction material for a clutch or brake disk, according to one embodiment.

Like reference numerals are used to indicate like elements throughout the several figures.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

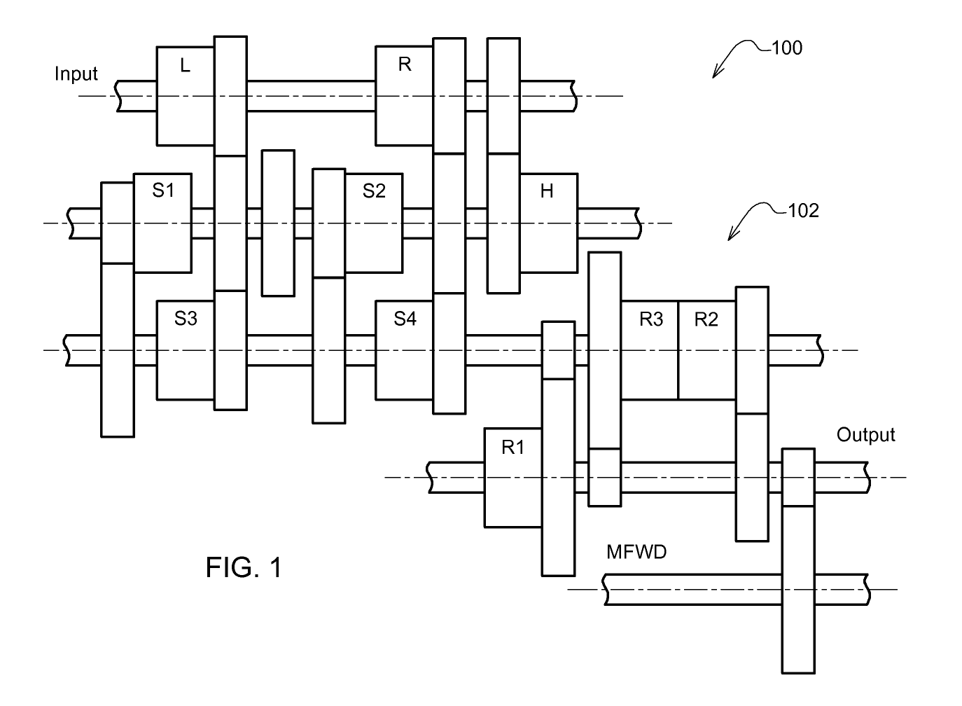

FIG. 1 illustrates a transmission 100 for a vehicle or work machine, such as a tractor, for example. The present disclosure also applies to other powered or motorized vehicles, machines, or equipment. The transmission 100 may include one or more clutches 102. For example, the transmission 100 may include input clutches L, H, R; speed clutches S1, S2, S3, and S4; and range clutches R1, R2, and R3, according to one embodiment.

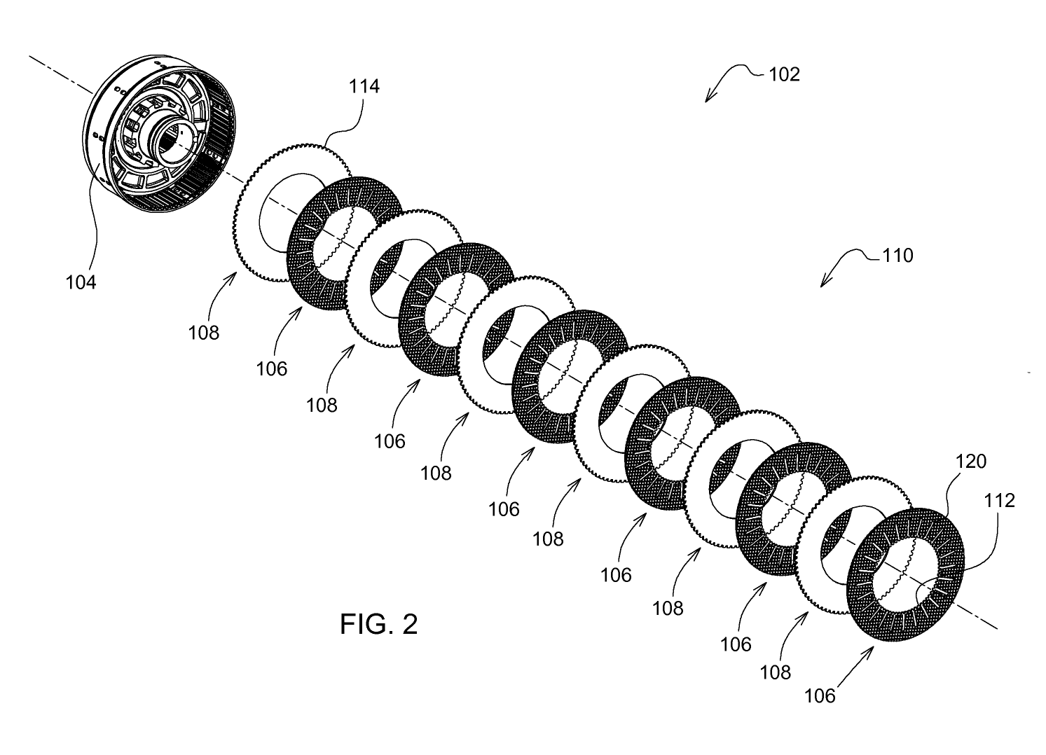

FIG. 2 illustrates a clutch 102, which may include a clutch drum 104, one or more clutch disks 106, and one or more clutch plates 108. The clutch disks 106 and clutch plates 108 may alternate forming a clutch pack 110. The clutch disks 106 and clutch plates 108 can be metal or steel plates. The clutch disks 106 may include friction material 120 on one or both sides of the disk 106. The clutch disks 106 may include splines 112 on the inner diameter to engage with corresponding splines or teeth on an adjoining hub or gear. The clutch plates 108 may include splines 114 on the outer diameter to engage with corresponding splines in the clutch drum 104. When the clutch 102 is engaged or partially engaged, fluid flows through a groove pattern in the friction material 120 cooling the friction material 120. When the clutch 102 is disengaged, there is relative motion between the clutch disks 106 and clutch plates 108. This relative motion creates windage or friction between the clutch disks 106 and the fluid, which can be reduced or minimized by the groove pattern in the friction material 120.

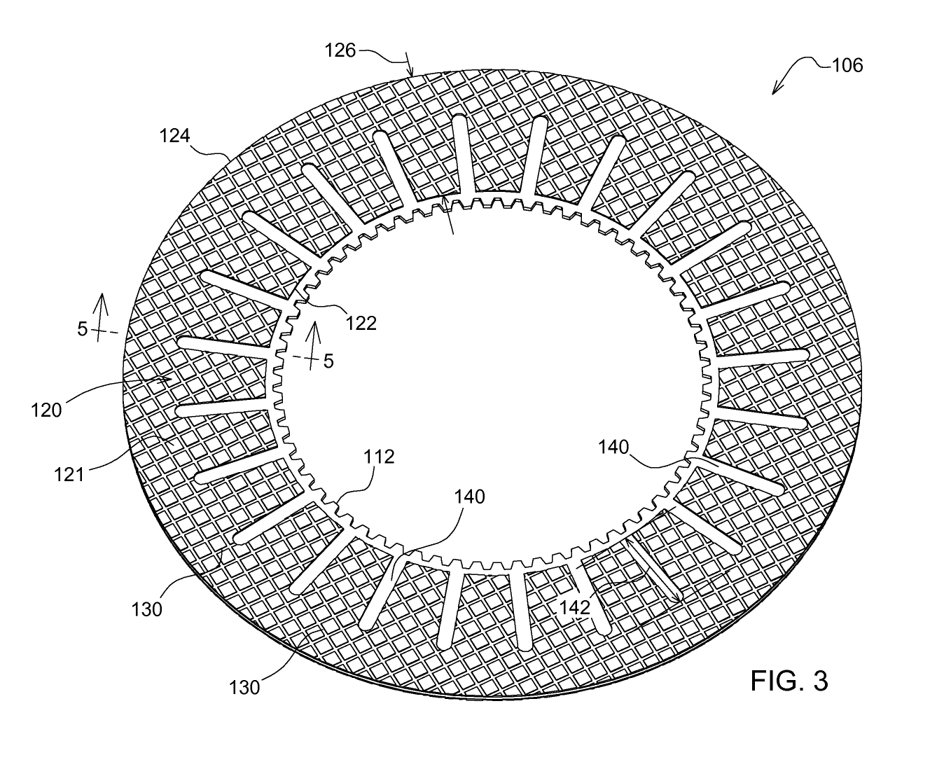

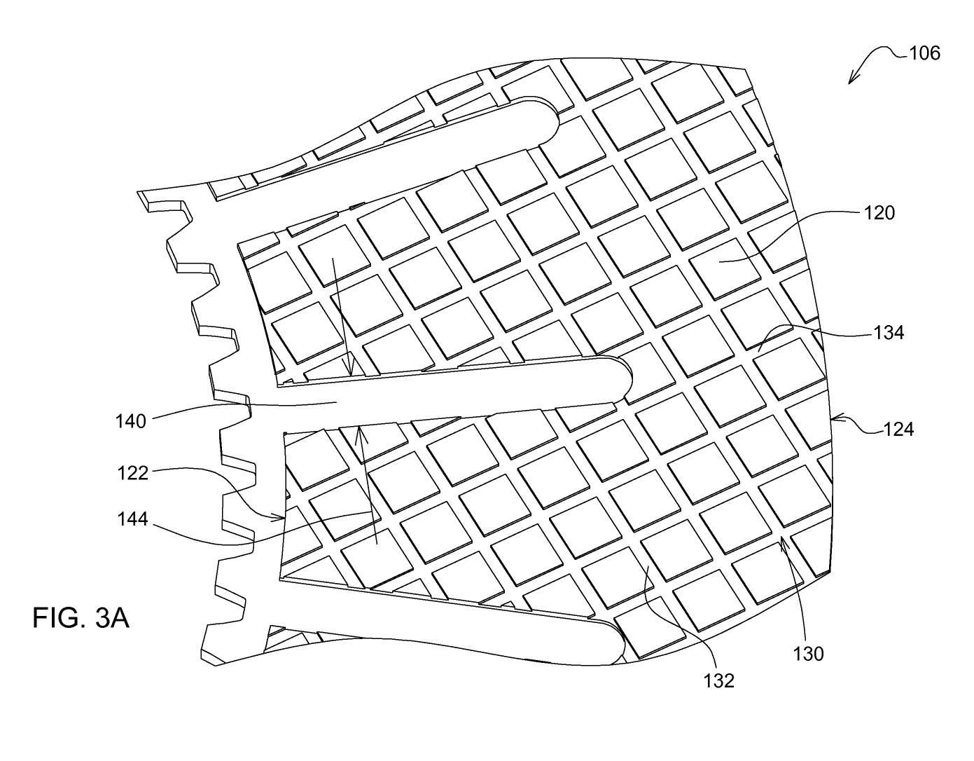

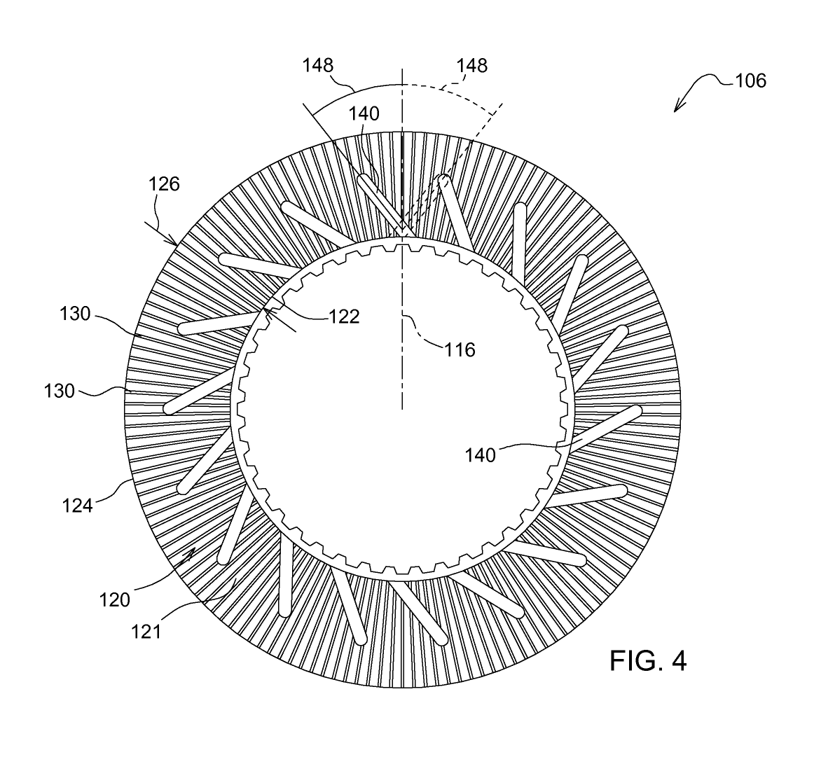

FIGS. 3 and 3A illustrate a friction disk 106, such as a clutch or brake disk, which may include friction material 120 on one or both sides of the disk. The friction material 120 can be a variety of different friction materials including, but not limited to relatively soft friction materials. The friction material 120 includes an inner diameter 122, an outer diameter 124, and a width 126. The friction material 120 may include a first plurality of grooves 130 and a second plurality of grooves 140. The first plurality of grooves 130 may include any pattern of grooves extending across the face or surface 121 of the friction material 120 in which the pattern of grooves forms one or more channels extending from the inner diameter 122 to the outer diameter 124 of the friction material 120. The first plurality of grooves 130 may include a waffle pattern. The first plurality of grooves 130 may include two groups or sets of parallel grooves 132, 134 intersecting at right angles or at other angles. The first group of grooves 132 has a first width and a first depth and the second group of grooves 132 has a second width and a second depth. The first and second widths may be substantially the same or different; and the first and second depths may be substantially the same or different. Alternatively, the first plurality of grooves 130 may include a sunburst pattern in which the grooves extend from the inner diameter 122 to the outer diameter 124 in the radial direction, as shown for example in FIG. 4. The first plurality of grooves 130 may be pressed or embossed in the surface 121 of the friction material 120. Pressed or embossed grooves can reduce the windage compared to cut grooves. Reducing the windage reduces the energy loss and increases efficiency.

The second plurality of grooves 140 may include radial grooves extending from the inner diameter 122 of the friction material 120 in the radial direction towards the outer diameter 124, as shown for example in FIGS. 3 and 3A. The second plurality of grooves 140 may intersect the inner diameter 122 of the friction material 120 and extend a length 142, which is less than the width 126 of the friction material 120. The second plurality of grooves 140 may end or terminate before the outer diameter 124. The second plurality of grooves 140 may all have the same length or they may have different lengths. The length 142 of the second plurality of grooves 140 may extend between 10-90%, 20-90%, 30-90%, 40-90%, 45-85%, 50-80%, 55-75%, 60-70%, or 60-65% of the width 126 of the friction material 120. The second plurality of grooves 140 may have a substantially uniform or constant width 144 along the length of each groove. The second plurality of grooves 140 may be wider than the first plurality of grooves 130.

The second plurality of grooves 140 may extend from the inner diameter 122 of the friction material 120 towards the outer diameter 124 at an angle 148 to the radial direction, as shown for example in FIG. 4. The angle 148 to the radial direction may be any angle or range of angles from 0° to 90° on either side of the radial line 116, either towards or away from the direction of rotation of the clutch or brake disk 106. The angle 148 to the radial direction or radial line 116 may include one or more ranges from 0° to 90°. The angle 148 may be greater than or equal to 1°, 2°, 5°, or 10°. Alternatively, the second plurality of grooves 140 may extend in the radial direction at an angle 148 within 1°, 2°, 5°, or 10° of the radial direction or radial line 116. Any combination of the first and second plurality of grooves 130, 140 may be used.

The first and second plurality of grooves 130, 140 interconnect such that fluid can flow between both pluralities of grooves 130, 140. For example, fluid can flow into the first plurality of grooves 130 or the second plurality of grooves 140 at or near the inner diameter 122 of the friction material 120. From the first plurality of grooves 130, the fluid can flow into the second plurality of grooves 140 or the fluid can continue in the first plurality of grooves 130 towards the outer diameter 124 of the friction material 120. From the second plurality of grooves 140, the fluid can flow into the first plurality of grooves 130 towards the outer diameter 124 of the friction material 120. From the first plurality of grooves 130, the fluid can exit the face or surface 121 of the friction material 120 at or near the outer diameter 124 of the friction material 120. The inclusion of the second plurality of grooves 140 with the first plural of grooves 130 increases the flow of fluid through the grooves, which increases the energy capacity of the friction material 120. The length, width, depth, and number of radial grooves 140 can be varied to regulate the volume of fluid flowing through the grooves, which affects the energy capacity of the friction material 120. Increasing fluid flow increases the energy capacity of the friction material 120; and decreasing fluid flow decreases the energy capacity of the friction material 120.

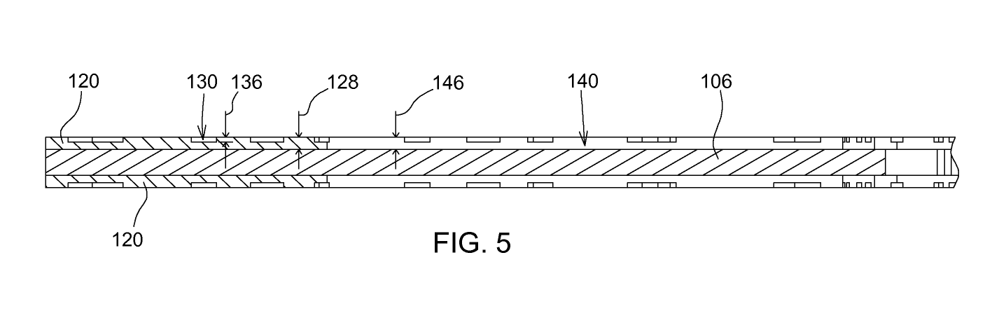

FIG. 5 illustrates a cross-sectional view of the clutch or brake disk 106 shown in FIG. 3. The friction material 120 may be on one or both sides of the disk 106. The first plurality of grooves 130 in the friction material 120 may include a depth 136. The second plurality of grooves 140 in the friction material 120 may include a depth 146. The depth 136 of the first plurality of grooves 130 may be constant or uniform. The depth 146 of the second plurality of grooves 140 in the friction material 120 may be constant or uniform. The depth 146 of the second plurality of grooves 140 can be greater than the depth 136 of the first plurality of grooves 130. The depth 146 of the second plurality of grooves 140 may extend through the thickness 128 of the friction material 120 to the clutch or brake disk 106. In this embodiment, the fluid within the second plurality of grooves 140 contacts the clutch or brake disk 106 increasing the transfer of heat between the fluid and the clutch or brake disk 106. The depth 146 of the second plurality of grooves 140 may vary along the length 142 of the groove. The depth 146 of the second plurality of grooves 140 may slope or incline along the length 142 so that the depth 146 at one end of the groove is shallower than the other end. The fluid in the second plurality of grooves 140 can provide a separation force when the clutch or brake is disengaged due to the amount of fluid in the second plurality of grooves 140.

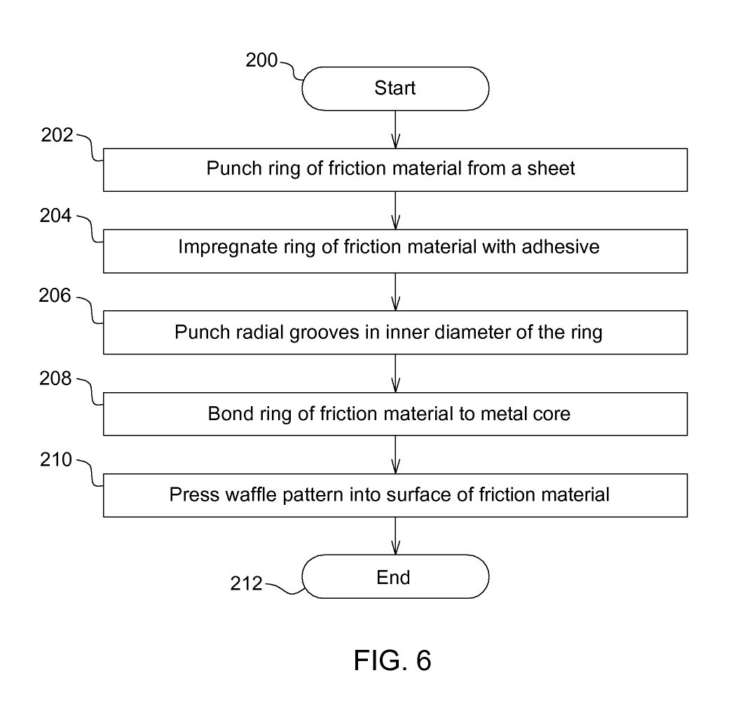

FIG. 6 illustrates a flow chart for a method of positioning grooves in the friction material for a clutch or brake disk, according to one embodiment, which may be implemented in one or more of the embodiments described herein and depicted in the various FIGURES. At step 200, the method starts.

At step 202, a ring is punched from a sheet of friction material having inner and outer diameters 122, 124.

At step 204, the ring of friction material 120 is impregnated with an adhesive, such as glue.

At step 206, radial grooves 140 are punched in the inner diameter 122 of the ring of friction material 120 and extend partially towards the outer diameter 124. The radial grooves 140 may extend through the thickness 128 of the friction material 120. The radial grooves 140 may have a substantially uniform width.

At step 208, the ring of friction material 120 is bonded to the metal core or disk 106.

At step 210, a pattern of grooves 130 is pressed or embossed into the surface of the friction material 120. This pattern of grooves 130 extends across the face of the friction material 120 and can be shallower than the radial grooves 140.

At step 212, the method of positioning grooves in the friction material for a clutch or brake disk completes, according to one embodiment. In other embodiments, one or more of these steps or operations may be omitted, repeated, or re-ordered and still achieve the desired results.

Without in any way limiting the scope, interpretation, or application of the claims appearing below, a technical effect of one or more of the example embodiments disclosed herein is a groove pattern in friction material which reduces windage or friction between the clutch or brake disk and the fluid. Another technical effect of one or more of the example embodiments disclosed herein is a groove pattern in friction material which provides high energy capacity. Another technical effect of one or more of the example embodiments disclosed herein is a groove pattern which maximizes the surface or facing area of the friction material. Another technical effect of one or more of the example embodiments disclosed herein is a groove pattern in friction material which provides a separation force between the disks and plates.

The terminology used herein is for the purpose of describing particular embodiments or implementations and is not intended to be limiting of the disclosure. As used herein, the singular forms “a”, “an” and “the” are intended to include the plural forms as well, unless the context clearly indicates otherwise. It will be further understood that the any use of the terms “has,” “have,” “having,” “include,” “includes,” “including,” “comprise,” “comprises,” “comprising,” or the like, in this specification, identifies the presence of stated features, integers, steps, operations, elements, and/or components, but does not preclude the presence or addition of one or more other features, integers, steps, operations, elements, components, and/or groups thereof.

The references “A” and “B” used with reference numerals herein are merely for clarification when describing multiple implementations of an apparatus.

One or more of the steps or operations in any of the methods, processes, or systems discussed herein may be omitted, repeated, or re-ordered and are within the scope of the present disclosure.

While the above describes example embodiments of the present disclosure, these descriptions should not be viewed in a restrictive or limiting sense. Rather, there are several variations and modifications which may be made without departing from the scope of the appended claims.

What is claimed is:

1. A friction disk comprising:
a disk; and
a friction material positioned on a first side of the disk;
the friction material including a first plurality of grooves extending across the width of the friction material, and a second plurality of grooves extending in a radial direction a length less than the width of the friction material, the second plurality of grooves having a substantially uniform width, the second plurality of grooves being deeper and wider than the first plurality of grooves, the first and second plurality of grooves being interconnected so that fluid can flow from the second plurality of grooves into the first plurality of grooves.

2. The friction disk of claim 1, wherein the first plurality of grooves comprises a waffle pattern.

3. The friction disk of claim 1, wherein the first plurality of grooves comprises a sunburst pattern.

4. The friction disk of claim 1, wherein the second plurality of grooves extends between 50% and 80% of the width of the friction material.

5. The friction disk of claim 1, wherein the second plurality of grooves extends at an angle to the radial direction greater than or equal to one degree.

6. The friction disk of claim 1, wherein the disk is a clutch disk.

7. The friction disk of claim 1, wherein the disk is a brake disk.

8. A friction disk comprising:
a disk; and
a friction material positioned on a first side of the disk;
the friction material including a first plurality of grooves extending from an inner diameter of the friction material to an outer diameter of the friction material, and a second plurality of grooves extending in a radial direction from the inner diameter and ending prior to the outer diameter, the second plurality of grooves having a substantially uniform width, the second plurality of grooves being deeper and wider than the first plurality of grooves, the first and second plurality of grooves being interconnected so that fluid can flow from the second plurality of grooves into the first plurality of grooves.

9. The friction disk of claim 1, wherein the first plurality of grooves comprises a waffle pattern.

10. The friction disk of claim 1, wherein the first plurality of grooves comprises a sunburst pattern.

11. The friction disk of claim 1, wherein the second plurality of grooves extends from the inner diameter to between 50% and 80% of the width of the friction material.

12. The friction disk of claim 1, wherein the second plurality of grooves extends at an angle to the radial direction greater than or equal to one degree.

13. The friction disk of claim 1, wherein the disk is a clutch disk.

14. The friction disk of claim 1, wherein the disk is a brake disk.

15. A method of positioning grooves in friction material for a friction disk comprising:
positioning a first plurality of grooves on the surface of the friction material, the first plurality of grooves extending from an inner diameter of the friction material to an outer diameter of the friction material; and
positioning a second plurality of grooves on the surface of the friction material, the second plurality of grooves extending from the inner diameter in a radial direction and ending prior to the outer diameter, the second plurality of grooves having a substantially uniform width, the second plurality of grooves being deeper and wider than the first plurality of grooves, the first and second plurality of grooves being interconnected so that fluid can flow from the second plurality of grooves into the first plurality of grooves.

16. The method of claim 11, wherein the second plurality of grooves are positioned on the friction material before the first plurality of grooves.

17. The method of claim 11, wherein the first plurality of grooves comprises a waffle pattern.

18. The method of claim 11, wherein the first plurality of grooves comprises a sunburst pattern.

19. The method of claim 11, wherein the second plurality of grooves extends from the inner diameter to between 50% and 80% of the width of the friction material.

20. The method of claim 11, wherein the second plurality of grooves extends at an angle to the radial direction greater than or equal to one degree.
